(19) United States
(12) Patent Application Publication
(10) Pub. No.: US 2012/0173326 A1
(43) Pub. Date: Jul. 5, 2012

(54) Keyword bid management in an online advertising system

(76) Inventors: David Tao, Sunnyvale, CA (US); Xingtao Zhao, Sunnyvale, CA (US); Rohit Kaul, Mountain View, CA (US)

(21) Appl. No.: 13/136,211

(22) Filed: Jul. 26, 2011

Related U.S. Application Data
(60) Provisional application No. 61/460,383, filed on Dec. 31, 2010.

(51) Int. Cl. G06Q 30/00

(52) U.S. Cl. 705/14.43

(57) ABSTRACT

In a technique for managing keyword bid amounts in an online advertising system (OAS), a closed-loop feedback technique that integrates data integration, keyword management, bid management, product-search results and user activities is used to optimize revenue generation from online advertisements for websites, such as e-commerce websites. In particular, bids on a group of keywords associated with products are based on an estimated profitability of the group of keywords. Then, the resulting traffic to an associated e-commerce website is monitored by determining a financial performance metric of the e-commerce website, which facilitates subsequent feed-back adaptation. For example, a layout of the e-commerce website (such as product information, which is associated with the products, and/or relative positions of the displayed product information on the e-commerce website) is adjusted based on the determined financial performance metric. Moreover, the bid amounts for the group of keywords are modified based on the determined financial performance metric.

### CROSS REFERENCE TO RELATED APPLICATIONS

This application claims priority under 35 U.S.C. 119(e) to U.S. Provisional Application Ser. No. 61/460,383, “Keyword Bid Management in an Online Advertising System,” by David Tao, Xingtao Zhao and Rohit Kaul, filed on Dec. 31, 2010, the contents of which are herein incorporated by reference.

### BACKGROUND

The present disclosure relates to techniques for managing keyword bid amounts in an online advertising system (OAS).

Search engines are increasingly popular tools for providing users information, such as documents or links to web pages, in response to user-provided search queries. These search queries typically include keywords, which are often used by search engines to identify and display associated advertising to users (so-called ‘paid search results’). Furthermore, the paid search results are often ordered or ranked based on factors, such as: the performance of a particular advertising link (for example, based on its relative click-through rate or CTR), the amount of money or the ‘bid amount’ paid by an advertiser to associate a keyword with the advertising, text that accompanies an advertisement (so-called ‘advertising-copy’), etc. In general, an online advertiser can obtain a higher position in the paid search ranking by offering a larger bid amount for a given keyword.

One type of online advertiser includes electronic-commerce (e-commerce) web pages or websites. These websites usually have an associated product catalog (which is sometimes referred to as a ‘feed’) that contains product information (such as a product description, title, image, price etc.), which is typically frequently refreshed as dictated by business needs. To facilitate identification of products on such e-commerce websites, comparison-shopping websites (which are sometimes referred to as ‘comparison-shopping engines’) routinely collect or aggregate the product information in these product catalogs from individual e-commerce websites or businesses, and merge them to produce a comparison-shopping search index. Users can leverage this comparison-shopping search index to obtain multiple offers for a desired product, as well as to identify multiple products in response to a keyword-based query.

In order to help drive users to a given e-commerce website or a comparison-shopping website, bid amounts may be placed on keywords on search engines so that an advertisement associated with the given e-commerce website or the comparison-shopping website appears in the paid search results displayed on a search-engine web page in response to search queries that include one or more of the keywords. Then, when a user activates an icon or a link associated with such an advertisement, the user may be redirected to the given e-commerce website or a comparison-shopping website.

As a consequence, selecting the correct keywords and determining the appropriate bid amounts can be very important in implementing a successful online advertising campaign. Furthermore, given the strong competition and narrow margins that are often associated with electronic commerce, these operations can have a strong impact on the profitability of the e-commerce websites and the comparison-shopping websites. However, the complex and dynamic nature of online networks, such as the Internet, have made it very difficult to evaluate keywords and the associated bid amounts, which can significantly complicate online advertising campaigns, as well as the successful operation of comparison-shopping websites and e-commerce websites.

### SUMMARY

The disclosed embodiments relate to a system that manages keyword bid amounts in an online advertising system (OAS). During operation, this system bids on a group of keywords in the OAS using bid amounts that are based on an estimated profitability of the group of keywords, where the group of keywords are associated with products provided by organizations. Then, the system monitors resulting traffic to an electronic-commerce (e-commerce) website, where the monitoring involves determining a financial performance metric associated with the e-commerce website. Moreover, the system adjusts a layout of the e-commerce website based on the determined financial performance metric. Note that the layout includes product information that is displayed on the e-commerce website and relative positions of the displayed product information on the e-commerce website, and the product information is associated with the products provided by the organizations. Next, the system modifies the bid amounts for the group of keywords based on the determined financial performance metric.

The OAS may provide paid search results associated with a search engine in response to search queries from users. Furthermore, the estimated profitability of a given keyword in the group of keywords may be determined based on an estimated revenue per click and an estimated click-through rate (CTR) of an icon or a link on the e-commerce website that is associated with an organization that provides a given product.

Note that the e-commerce website may include a comparison-shopping engine, and the product information displayed on the comparison-shopping engine may be associated with web pages or websites of the organizations. Furthermore, a user may be referred to the comparison-shopping engine in response to the user activating an icon or a link in paid search results that are generated by a search engine in response to a search query of the user.

Additionally, the financial performance metric may include revenue of the e-commerce website. For example, the revenue may be based on a traffic volume to the e-commerce website and revenue per user visit to the e-commerce website. Moreover, the revenue per user visit may be based on the bid amounts and user CTRs for icons on the e-commerce website that are associated with the products.

In some embodiments, dynamically adjusting the layout maximizes the determined financial performance metric.

Furthermore, the bidding, the monitoring, the adjusting and the modifying operations may be performed on an ongoing basis. Alternatively or additionally, adjusting the layout and/or modifying the bid amounts may be performed: once, after a time interval since a previous adjustment or continuously.

In some embodiments, the system increases the bid amounts above values that are based on the estimated profitability of the group of keywords to increase traffic volume and a quality of the traffic to the e-commerce website. Moreover, note that the quality of the traffic includes users with increased revenue per user visit to the e-commerce website relative to the revenue per user visit associated with other users when the bid amounts equal the values.

In some embodiments, the system deactivates one or more keywords in the group of keywords if a web page or website of an organization, which provides a product associated with the one or more keywords, is offline, thereby maintaining the financial performance metric associated with the e-commerce website. Deactivating the one or more keywords may involve removing associated bid amounts from the OAS and terminating subsequent processing of the one or more keywords in the method. Subsequently, the system may reactivate the one or more keywords in the group of keywords when the web page or website of the organization is back online.

Another embodiment provides a method that includes at least some of the operations performed by the system.

Another embodiment provides a computer-program product for use with the system. This computer-program product includes instructions for at least some of the operations performed by the system.

### BRIEF DESCRIPTION OF THE FIGURES

FIG. 1 is a flow chart illustrating a method for managing keyword bid amounts for use in an online advertising system (OAS) in accordance with an embodiment of the present disclosure.

FIG. 2 is a flow chart illustrating the method of FIG. 1 in accordance with an embodiment of the present disclosure.

FIG. 3 is a block diagram illustrating a search-engine marketing system in accordance with an embodiment of the present disclosure.

FIG. 4 is a block diagram illustrating interactions in the search-engine marketing system of FIG. 3 in accordance with an embodiment of the present disclosure.

FIG. 5 is a block diagram illustrating click-through rate (CTR) calculation and ranking in the search-engine marketing system of FIG. 3 in accordance with an embodiment of the present disclosure.

FIG. 6 is a block diagram illustrating a computer system in the search-engine marketing system of FIG. 3 that performs the method of FIGS. 1 and 2 in accordance with an embodiment of the present disclosure.

FIG. 7 is a block diagram illustrating a data structure for use in the computer system of FIG. 6 in accordance with an embodiment of the present disclosure.

FIG. 8 is a block diagram illustrating changes to a layout of an e-commerce website in accordance with an embodiment of the present disclosure.

FIG. 9 is a block diagram illustrating a data structure for use in the computer system of FIG. 6 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a technique for managing keyword bid amounts in an online advertising system (OAS), a closed-loop feedback technique that integrates data integration, keyword management, bid management, product-search results and user activities is used to optimize revenue generation from online advertisements for websites, such as e-commerce websites. In particular, bids on a group of keywords associated with products are based on an estimated (i.e., feed-forward) profitability of the group of keywords. Then, the resulting traffic to an associated e-commerce website is monitored by determining a financial performance metric of the e-commerce website, which facilitates subsequent feed-back adaptation. For example, a layout of the e-commerce website (such as product information, which is associated with the products, and/or relative positions of the displayed product information on the e-commerce website) is adjusted based on the determined financial performance metric. Moreover, the bid amounts for the group of keywords are modified based on the determined financial performance metric.

By updating and optimizing the keyword bid amounts and the website layout, this management technique facilitates improved online-advertising campaign management, which may result in increased traffic to and improved profitability of online advertisers, such as e-commerce websites, as well as for search engines and comparison-shopping engines that provide services to online advertisers. In the process, the management technique may increase commercial activity and/or customer loyalty.

In the discussion that follows, the entities associated with e-commerce websites may include merchants, retailers, resellers and distributors, including online and physical (or so-called ‘brick and mortar’) establishments. These entities are sometimes referred to as ‘organizations.’ Furthermore, a search engine may include a system that retrieves documents (such as files) from a corpus of documents and, more generally, provides ‘search results’ (including information and/or advertising) in response to user-provided search queries. Additionally, a comparison-shopping engine (such as Become, Inc. of Sunnyvale, Calif.) may include a system that: compares attributes (such as prices and/or features) and reviews of products offered by third parties; and which can identify multiple products in response to keyword-based search queries from users. Note that an OAS (which is sometimes referred to as an advertising network) may be implemented via a search engine and/or a comparison-shopping engine, and may be used by entities to drive traffic volume to their websites. In particular, in response to search queries, an OAS may provide keyword-matched advertising, which are ranked based on: bid amounts, performance (such as a click-through rate or CTR of a given advertisement), and advertising copy or text. In addition, a ‘query’ may refer to a keyword that is analyzed for potential publication to the OAS, or may indicate a user query to a search engine or a comparison-shopping engine that can include multiple keywords.

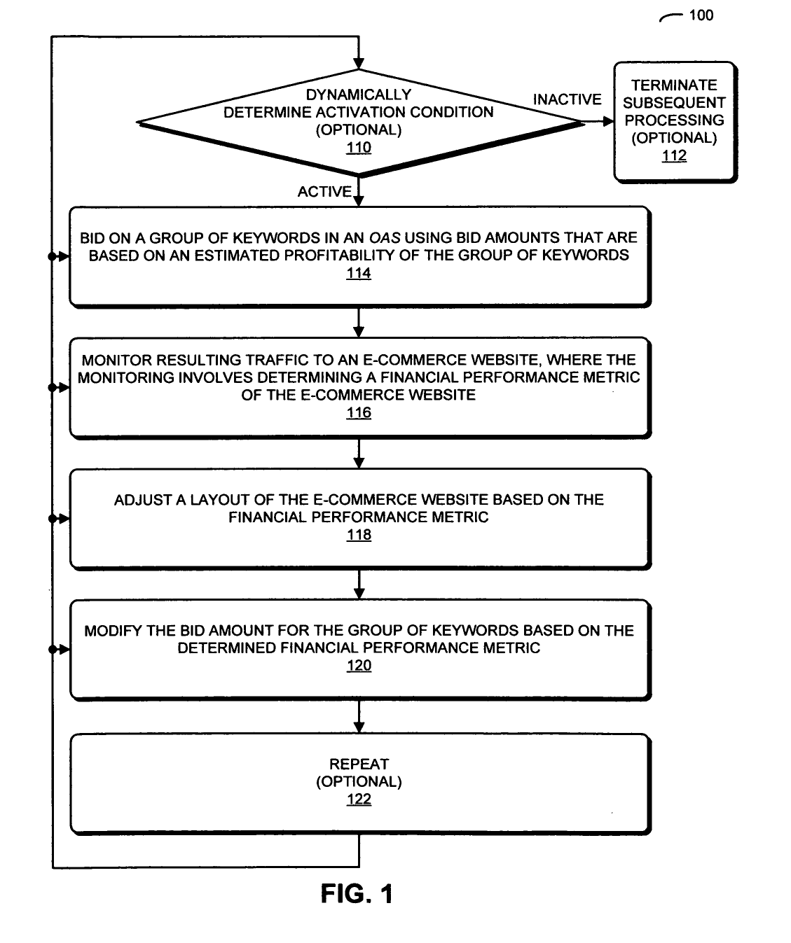

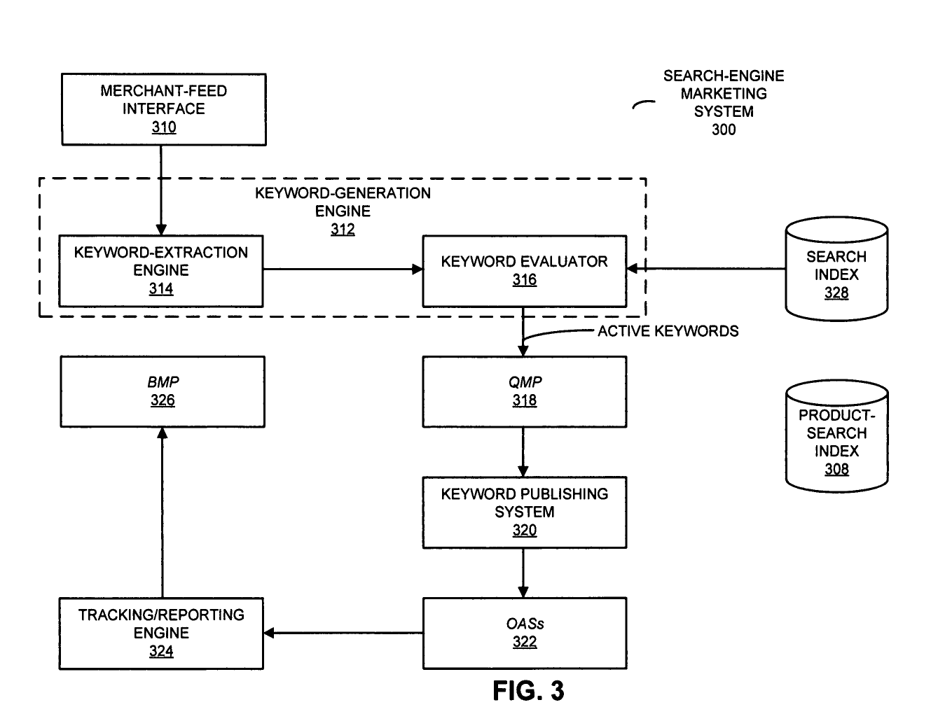

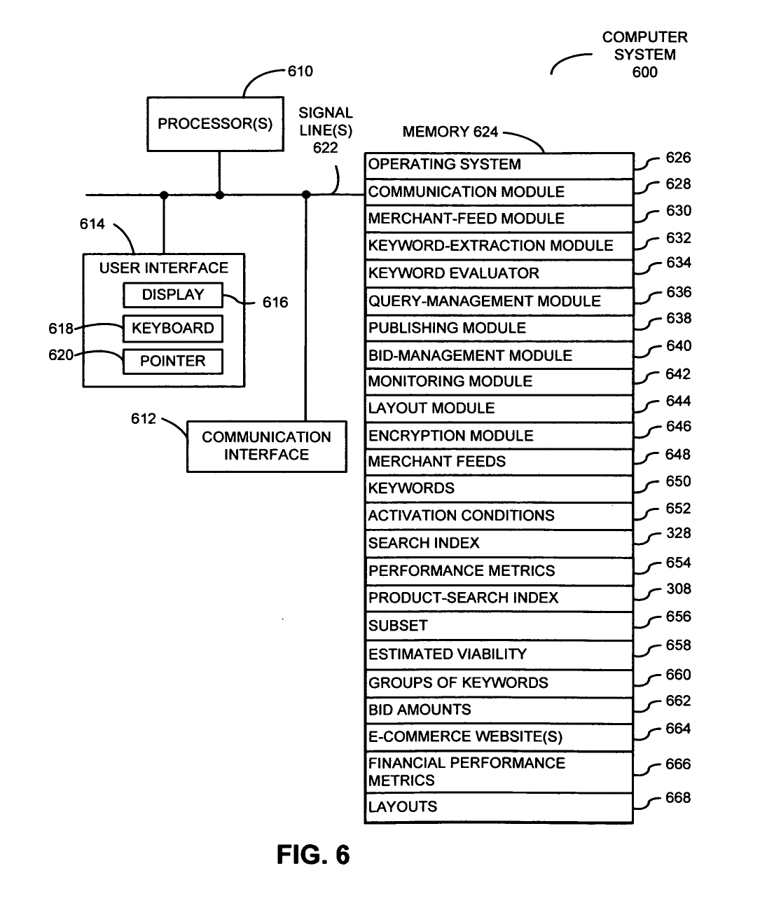

We now describe embodiments of the management technique. FIG. 1 presents a flow chart illustrating a method 100 for managing keyword bid amounts for use in an online advertising system (OAS), which may be performed by search-engine marketing system 300 (FIG. 3) and/or computer system 600 (FIG. 6). Note that the OAS may provide paid search results associated with a search engine in response to search queries from users.

During operation, this system bids on a group of keywords (such as one or more advertising groups in an online-advertising campaign) in the OAS using bid amounts that are based on an estimated profitability of the group of keywords (operation 114), where the group of keywords are associated with products provided by organizations. The estimated profitability of a given keyword in the group of keywords may be determined based on an estimated revenue per click and an estimated CTR of an icon or a link on the e-commerce website that is associated with an organization that provides a given product.

Then, the system monitors resulting traffic to an e-commerce website or web page (operation 116), where the monitoring involves determining a financial performance metric associated with the e-commerce website. The financial performance metric may include revenue of the e-commerce website. For example, the revenue may be based on a traffic volume to the e-commerce website and revenue per user visit to the e-commerce website. Moreover, the aggregate revenue per user visit (which is sometimes referred to as a ‘click-out rate’) may be based on the bid amounts and user CTRs for icons or links on the e-commerce website that are associated with the products. In particular, the aggregate revenue per user visit may be based on the bid amounts multiplied by the corresponding user CTRs for the products.

Note that the e-commerce website may include a comparison-shopping engine, and the product information displayed on the comparison-shopping engine may be associated with web pages or websites of the organizations. Furthermore, a user may be referred to the comparison-shopping engine in response to the user activating an icon or a link in paid search results that are generated by a search engine in response to a search query of the user. Alternatively or additionally, the e-commerce website may be associated with an entity, such as an online retailer. (Thus, in the discussion that follows, e-commerce website should be understood to include a comparison-shopping engine or a website associated with an organization, such as a merchant or an entity.)

Subsequently, the system adjusts a layout of the e-commerce website based on the determined financial performance metric (operation 118). The layout may include product information that is displayed on the e-commerce website and relative positions of the displayed product information on the e-commerce website, and the product information may be associated with the products provided by the organizations. Furthermore, dynamically adjusting the layout may maximize the determined financial performance metric.

Next, the system modifies the bid amounts for the group of keywords based on the determined financial performance metric (operation 120).

In some embodiments, the bidding, the monitoring, the adjusting and the modifying operations may be performed on an ongoing basis. Alternatively or additionally, adjusting the layout and/or modifying the bid amounts may be performed: once, after a time interval since a previous adjustment or continuously. Consequently, operations in method 100 may be optionally repeated (operation 122) two or more times.

Furthermore, in order to appropriately adjust the layout and/or to modify the bid amounts, the system may temporarily perform a so-called ‘investment cycle.’ In particular, during an investment cycle, the system may optionally increase the bid amounts above values that are based on the estimated profitability of the group of keywords to increase traffic volume and the quality of the traffic to the e-commerce website. Moreover, note that the quality of the traffic includes users with increased revenue per user visit to the e-commerce website relative to the revenue per user visit associated with other users when the bid amounts equal the values. Information collected during an investment cycle may be used to determine which keywords resulted in good impressions (i.e., led to traffic to the e-commerce website), such the keywords with high CTRs on icons or links in associated online advertising, which may provide sufficient information to allow the revenue, traffic volume and/or profitability of the e-commerce website to be optimized (for example, dynamically).

In some embodiments the system optionally deactivates one or more keywords in the group of keywords if a web page or website of an organization, which provides a product associated with the one or more keywords, is offline. Deactivating the one or more keywords may involve removing associated bid amounts from the OAS and terminating subsequent processing of the one or more keywords in the method. Subsequently, the system may optionally reactivate the one or more keywords in the group of keywords when the web page or website of the organization is back online. This may deactivating and activating may ensure that sufficient products associated with the group of keywords are currently available from the organizations, thereby maintaining the financial performance metric associated with the e-commerce website. Thus, the system may optionally dynamically determine an activation condition of a group of keywords (operation 110) and, if the group of keywords are inactive, the system may (at least temporarily) optionally terminate subsequent processing of the group of keywords (operation 112) in method 100.

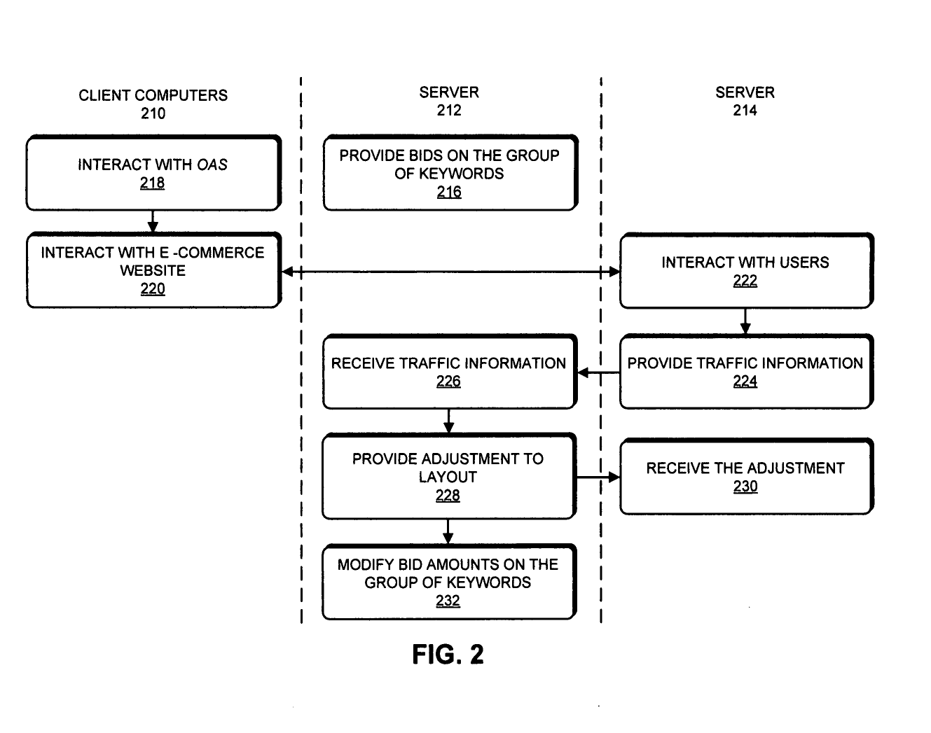

In an exemplary embodiment, the publishing technique is implemented using one or more client computers and at least one server computer, which communicate through a network, such as the Internet (i.e., using a client-server architecture). This is illustrated in FIG. 2, which presents a flow chart illustrating method 100 (FIG. 1). During this method, server 212 provides bids on the group of keywords (operation 216) to an OAS using bid amounts that are based on an estimated profitability of the group of keywords.

Subsequently, users of client computers 210 interact with the OAS (operation 218). For example, OAS may include a search engine, and the interaction may involve a given user: entering a search query on OAS; in response to the search query, receiving search results that include paid search results; activating an icon or a link associated with one of the paid search results, which is associated with a product offered by an entity; and being redirected to server 214, which hosts an e-commerce website that is associated with the entity. Then, the users may interact with server 214 (operations 220 and 222), which may include optionally conducting a financial transaction via the e-commerce website (such as purchasing a product that is sold by the entity or, if the entity is a comparison-shopping engine, being redirected to another e-commerce website that is associated with another entity and purchasing the product). Moreover, server 214 may provide (operation 224) and server 212 may receive information (operation 226) associated with the traffic to the e-commerce website, including determining the financial performance metric.

Furthermore, server 212 may provide (operation 228) and server 214 may receive (operation 230) an adjustment the layout of the e-commerce website based on the determined financial performance metric. Furthermore, server 212 may modify the bid amounts for the group of keywords (operation 232) based on the determined financial performance metric.

In some embodiments of method 100 (FIGS. 1 and 2) there may be additional or fewer operations. For example, in some embodiments server 212 may host the e-commerce website. In these embodiments, operations 224 and 230 may be eliminated, and operation 222 may be performed by server 212. Moreover, operation 226 may be modified so that server 212 ‘monitors’ the traffic information. Note that the order of the operations may be changed, and/or two or more operations may be combined into a single operation.

FIG. 3 presents a block diagram illustrating a search-engine marketing system 300, which may be associated with a comparison-shopping engine, and which may perform method 100 (FIGS. 1 and 2). Each day, merchants may submit catalogs (which contain product information associated with millions of products) to this search-engine marketing system using a merchant-feed interface 310. In particular, the merchant feeds may be files (in a tab-separated format, a comma-separated format or an eXtensible Markup Language format) that contain the product information for each product (such as the title, the description, the price, etc.). These merchant feeds typically go through a normalization process, after which all the ‘active’ feeds are uploaded, for example, on a daily basis, to a data structure to build a product-search index 308 using product-search techniques. This product-search index may include all of the products (and, thus, may have the same search results as the e-commerce websites). It may be used by a comparison-shopping engine to determine responses or search results for user queries. For example, if a user enters a query “lcd tv” in a web-page search box, the search results may include one or more products that contained “lcd” and “tv” in the product information provided by the merchants or in machine-generated information (which may be determined during the normalization process). As described further below in the discussion of revenue optimization, the search results may be tuned based on user interactions with previous search results to increase relevancy (which is sometimes referred to as a ‘feedback integrated relevancy engine’ or FIRE). Thus, if certain products are repeatedly selected by users, these products may have higher rankings in the search results, while those that have many impressions (being shown to user) but fewer clicks may have lower rankings.

The product information may also be processed by a keyword-generation engine 312, which includes keyword extraction engine 314 and keyword evaluator 316. In particular, keyword extraction engine 314 may classify the products based on an internal taxonomy. Then, for products classified to a given taxonomy node, a one-time process (which may be performed manually) may specify regular expression rules to extract keyword attributes (for example, a brand name or product properties, such as a size of a television). In addition, keyword evaluator 316 may dynamically determine an activation condition of one or more of the extracted keywords based on the associated numbers of products provided by the entities, which are included in search index 328. For example, an extracted keyword may be ‘active’ if an entity provides more than a predefined number of products that are associated with the extracted keyword. If the dynamically determined activation condition for a given keyword indicates that the given keyword is inactive, subsequent processing of the given keyword may be terminated. However, if the dynamically determined activation condition for the given keyword, which is currently inactive, subsequently indicates that the given keyword is active, subsequent processing of the given keyword may be reactivated.

Moreover, a query-management platform (QMP) 318 may be used, for example, daily, to generate keywords from millions of merchant products, as well as to estimate the associated revenue per user visit (which is used to determine the initial bid amounts on one or more OASs 322). The revenue per visit may be estimated using one or more performance metrics that are determined by QMP 318, including: a performance metric that is independent of the product information; a performance metric that is based on the product information; an OAS performance metric, and/or a search-engine performance metric. For example, the performance metric that is independent of the product information may include: a metric that indicates an association between the given keyword and a probability that a user is shopping for a product (which is sometimes referred to as ‘shopping intent’); and/or a metric that indicates a preferred ordering of terms in the given keyword. Moreover, the performance metric that is based on the product information may include: a grade associated with the given keyword that estimates its profitability when used in OASs 322; an estimated quality score that indicates a relative performance of the given keyword in the paid search results that are generated by the search engine in response to the user search queries; an estimate of revenue associated with the given keyword during a visit by a user to a location (such as a website) associated with one of the entities; a product classification associated with the given keyword; and/or an attribute associated with the given keyword. Furthermore, the OAS performance metric may include: a query volume, which is associated with the given keyword, in a search engine; and/or a metric of bid competition in OASs 322 associated with the given keyword. (These and other aspects of search-engine marketing system 300 are further described in U.S. Provisional Patent Application Ser. No. 61/456,771, by Rohit Kaul and David Tao, entitled “Keyword Publication for Use in Online Advertising”, filed on Nov. 13, 2010, and having attorney docket number BEC 10-0001, the contents of which are hereby incorporated by reference.)

Furthermore, QMP 318 may select a subset of the keywords based on an estimated viability of the keywords when used in OASs 322 (such as an estimated profitability), where the estimated viability is determined using the calculated performance metrics. For example, the estimated viability may be determined based on an estimated revenue per click and an estimated CTR of an icon (such as a link) on a comparison-shopping engine (which is sometimes referred to as an estimated ‘click out rate’) that is associated with one of the entities which provides a given product, thereby specifying the user revenue per visit. Note that a user may be referred to the comparison-shopping engine in response to the user activating another icon in the paid search results that are generated by the search engine in response to a search query of the user. In addition, note that the selected subset of the keywords may, in effect, pause/unpause keywords in anticipation of their performance (which may be important for keywords with low traffic volumes).

Keywords in the subset may be assigned to one or more online-advertising campaigns by a keyword publishing system 320 based on their taxonomy mapping and, within a given online-advertising campaign, the keywords may be assigned by keyword publishing system 320 to one or more advertising groups based on the attributes associated with a particular search query, and the classifications of the keywords and the lexicographic similarity between the keywords.

Note that multiple targeted advertising copies or advertising text (which may be used in online advertising) may be generated by keyword publishing system 320 based on the keyword attributes and a common construction template associated with a given group of keywords. For example, using the construction template “Compare prices for <brand> <product-type> with <attribute value> <attribute name> <attribute name>”, the advertising text “Compare prices for Sony lcd tv with 1080p resolution” can be generated. This capability may enable keyword publishing to OASs 322 on a large scale.

Once the keywords are submitted to OASs 322, a bid-management platform 326 (BMP) may control the bid amounts on the keywords based on additional performance metrics provided by tracking/reporting engine 324. In particular, these performance metrics may be used to determine keyword profitability. In addition, BMP 326 may dynamically reassign one or more keywords from one advertising group to another based on a quality score that is received from OASs 322. For example, by moving keywords to different advertising groups based on the quality scores, keywords in a given advertising group may have similar quality scores. Note that the quality score may indicate the relative performance of at least the one keyword in the paid search results that are generated by a search engine in response to user search queries. For example, a given quality score may represent a ‘user experience’ as indicated by an associated CTR on the search engine, as well as based on the performance of the associated website(s) (such as how long users stay on the website(s), how rapidly web pages in the website(s) load, etc.).

In some embodiments, when a classification or taxonomy of a given keyword is changed, BMP 326 may also move the given keyword to a different advertising group, thereby changing the associated creative content (such as the advertising text).

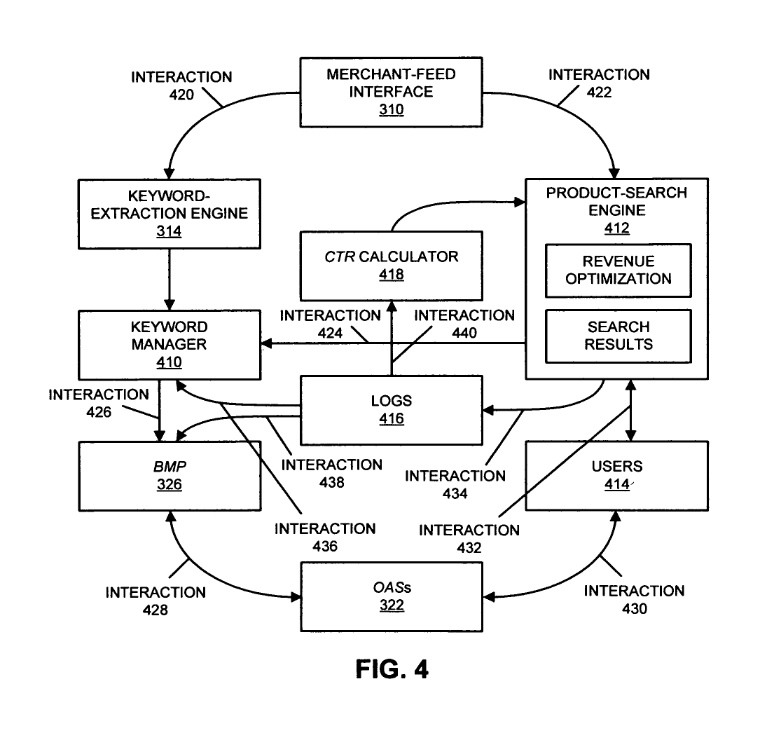

As noted previously, initially, for a particular amount of time, bids on the keywords provided by BMP 326 may be increased so that they have a profit target close to zero. This is sometimes referred to as an ‘investment cycle.’ An investment cycle may be used to maximize the traffic volume to an e-commerce website, which may enable the product-search FIRE ranking to collect user data and to improve the search-result relevancy by considering merchant bids, thereby increasing the revenue per visit. The increase revenue may allow BMP 326 to increase the bid amount, which, in turn, may improve the traffic volume and the traffic quality for a given keyword. Even after the end of investment cycle, when BMP 326 operates the active keyword portfolio at a certain return of investment (ROI) or profit, there may be a continuous feedback mechanism in place that allows the product-search yield optimization and BMP 326 to act in tandem (which is described further below with reference to FIG. 4).

Note that information in search-engine marketing system 300 may be stored at one or more locations in search-engine marketing system 300 (i.e., locally or remotely). Moreover, because this data may be sensitive in nature, it may be encrypted.

The feedback mechanisms between keyword management, bid management and product search are illustrated in FIG. 4, which presents a block diagram illustrating interactions in search-engine marketing system 300 (FIG. 3). In particular, the interactions are between: merchant-feed interface 310 (which receives merchant feeds), keyword-extraction engine 314, keyword manager 410 (which includes keyword evaluator 316 and QMP 314 in FIG. 3, and which determine which keywords to publish and at what bid amounts), product-search engine 412 (which generates product-search index 308 in FIG. 3, and which may optimize revenue of the e-commerce website), BMP 326 (which performs bid management), OASs 322, users 414, logs 416 and click-through-rate (CTR) calculator 418 (which determines CTRs and associated rankings).

In FIG. 4, when users 414 click on online advertisements on search engines, they may be directed to a ‘landing’ web page in an e-commerce website, which is associated with one or more keywords that were published to OASs 322. Once the user is on the e-commerce website, he or she may subsequently query for more products or navigate through the website. Note that there are several revenue-generating events during this process, for example, there may be multiple click-out events to merchants or entities. During a visit to the e-commerce website, the users' interactions may be logged in logs 416 for subsequent incorporation of user feedback into the rest of search-engine marketing system 300 (FIG. 3). These logs may include information that is recorded during a given user's visit to the e-commerce website, such as: a keyword bid on one or more of OASs 322, the landing web page, user queries, products displayed, products that the user clicked on, and/or total revenue generated per visit.

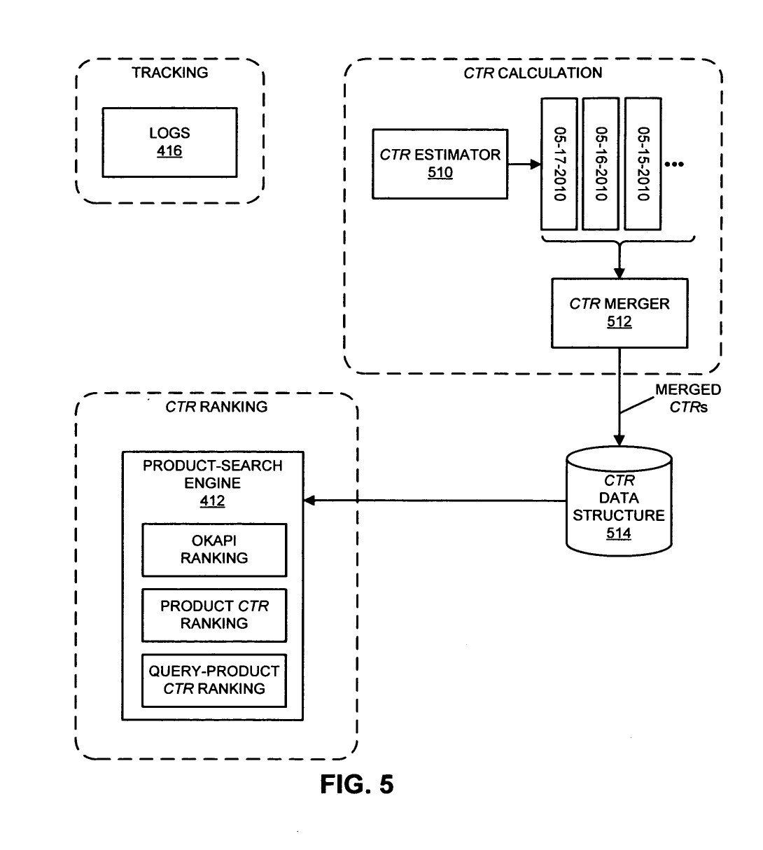

Furthermore, CTR calculator 418 may collate user logs over a period of time (such as the last 60-90 days) and may generate CTRs for a product, either independently of or based on search queries. Because of the sparsity of data, the CTRs may be calculated using a probabilistic technique. This calculation is described in FIG. 5, which presents a block diagram illustrating CTR calculation and ranking in search-engine marketing system 300 (FIG. 3). In particular, information in logs 416 (such as CTR logs) may be used by CTR estimator 510 to determine CTRs for a given product as a function of time (such as daily). These calculated CTRs may be combined by CTR merger 512, and the resulting aggregated or merged CTRs may be stored in a CTR data structure 514. Moreover, the stored CTRs may be used by product-search engine 412 to rank products for particular builds of product-search index 308 (FIG. 3). In order to optimize revenue, the product-search results in product-search index 308 (FIG. 3) may be sorted based on: an Okapi relevancy function (which uses the relatedness of keywords, and which may be useful for sparse results), a ranking using the calculated CTRs which is independent of queries (i.e., a product CTR ranking), and a ranking using the calculated CTRs which is based on queries (i.e., a query-product CTR ranking). In either of these later two rankings, the products with similar relevancy (such as those with Okapi relevancy no less than 80-90% of that for the current product) may be sorted based on the product of CTR and a bid amount.

In an exemplary embodiment of the CTR and ranking calculation, suppose there is a CTR for a given product for a query, then the probability that the product will get c clicks in n impressions may assume the Binomial distribution,

$$P ( c \vert CTR , n ) = ( \begin{matrix}n \\ c\end{matrix} ) \cdot {CTR}^{c} \cdot {( 1 - CTR )}^{n - c} .$$

Then, given impressions n and clicks c, the posterior probability of CTR is

$$P ( CTR \vert c , n ) = \frac{P ( c \vert CTR , n ) \cdot P ( CTR \vert n )}{P ( c \vert n )} = k \cdot {CTR}^{c} \cdot {( 1 - CTR )}^{n - c} \cdot P ( CTR ) ,$$

where P(CTR) is the prior CTR distribution which is supposed to be independent to the impression n, and

$$k = \frac{( \begin{matrix}n \\ c\end{matrix} )}{P ( c \vert n )}$$

is a constant given n and c. By creating a histogram from all trustful CTRs (such as those with a number of impressions greater than 50), the typical prior CTR distribution can be obtained. This prior CTR distribution can be fit with

P(CTR)=k₀·CTR^{c}^{₀}·(1−CTR)ⁿ^{₀}^{-c}^{₀}.

(Note that the fitting is often an approximation. Often, the actual distribution may have multiple peaks, such as one peak for high volume products and one peak for low volume products, or one peak for high CTR products and one peak for low CTR products.)

Because the position or ranking at which a product is shown can bias its CTR, the CTRs may be normalized by rank. By calculating the average CTR for each position, with the impressions and clicks aggregated over the user activities in one day (and, more generally, during a time interval), the position effects are calculated as

βₚₒₛ=CTRₚₒₛ/CTR₁.

Moreover, the final posterior probability of CTR can be described by a Beta Distribution,

$$P ( CTR \vert c , n ) = {k}^{′} \cdot {CTR}^{{\sum }_{pos} {c}_{pos} + {c}_{0}} \cdot {( 1 - CTR )}^{{\sum }_{pos} {β}_{pos} \cdot npos - {c}_{pos} + {n}_{0} - {c}_{0}} .$$

Referring back to FIG. 4, the interactions or feedback mechanisms may include: interaction 420, in which merchant feeds are processed (for example, daily) to generate new keywords; and interaction 422, in which the merchant feeds are processed (for example, daily) to create a new product-search index for products. Moreover, during interaction 424, keyword manager 410 may run product-search queries (for example, daily) to pause keywords before the cumulative loss is determined in reaction to the loss of product coverage by an entity. (In addition, the keyword classification and attributes may be determined by querying landing web-page information from the product-search index, and performance metrics, such as the expected revenue per click may be computed.) Then, during interaction 426, keyword manager 410 may also evaluate millions of keywords daily based on updated performance metrics, which may be used to determine the order in which the keywords are published. In conjunction with the performance estimates, publishing information (which may be used to determine the advertising campaign(s) and advertising group(s)) and the best estimate for starting bid amounts may also be provided.

Furthermore, during interaction 428, BMP 326 may adapt to cost information from OASs 322, and may send updates (such as: adding, deleting, pausing or unpausing keywords, changing advertising-groups of keywords because of internal evaluation or OAS quality updates). Additionally, interaction 430 may represent users clicking on the e-commerce advertising to get to the product-search landing web page. Interaction 432 may represent users interacting with an e-commerce website (or bounce back) once the users view the landing web page. These interactions may include: filtering the search results, performing additional queries and/or clicking out to a merchant's product web page.

Note that interaction 434 may represent user activity on the website, and the products displayed/clicked on may be stored in one or more of logs 416. Similarly, interaction 436 may indicate that information for user activity is used to periodically update the estimated keyword performance metrics (such as: keyword grade, shopping intent, expected click-out rate, etc.).

During interaction 438, the revenue generating events associated with a user's visit may be used to evaluate the revenue per visit of one or more keywords, advertising-groups and/or a larger aggregation of advertising-groups. In conjunction with OAS information, this may be used to determine bid amounts at a keyword and/or at an aggregated level.

Moreover, during interaction 440, user activity logs in logs 416 may be used to compute the CTR of a search query-product pair and/or for a product (independently of a search query).

Furthermore, note that during the CTR calculation and revenue optimization, CTR calculator 418 may feed back to product-search engine 412 to improve the yield for a results web page or website. In turn, the improved yield information may flow back to BMP 326, which may allow BMP 326 to increase bid amounts. This can result in a higher advertising-rank, as well as more traffic volume (which can improve the results further). As noted previously, this process may be jump started during the initial keyword deployment, where the bid amount may be placed at near-zero expected margin to favor exploration (i.e., during an investment cycle).

FIG. 6 presents a block diagram illustrating a computer system 600 in search-engine marketing system 300 (FIG. 3), which may performs method 100 (FIGS. 1 and 2). Computer system 600 includes one or more processing units or processors 610, a communication interface 612, a user interface 614, and one or more signal lines 622 coupling these components together. Note that the one or more processors 610 may support parallel processing and/or multi-threaded operation, the communication interface 612 may have a persistent communication connection, and the one or more signal lines 622 may constitute a communication bus. Moreover, the user interface 614 may include: a display 616, a keyboard 618, and/or a pointer 620, such as a mouse.

Memory 624 in computer system 600 may include volatile memory and/or non-volatile memory. More specifically, memory 624 may include: ROM, RAM, EPROM, EEPROM, flash memory, one or more smart cards, one or more magnetic disc storage devices, and/or one or more optical storage devices. Memory 624 may store an operating system 626 that includes procedures (or a set of instructions) for handling various basic system services for performing hardware-dependent tasks. Memory 624 may also store procedures (or a set of instructions) in a communication module 628. These communication procedures may be used for communicating with one or more computers and/or servers, including computers and/or servers that are remotely located with respect to computer system 600.

Memory 624 may also include multiple program modules (or sets of instructions), including: a merchant-feed module 630 (or a set of instructions), a keyword-extraction module 632 (or a set of instructions), keyword evaluator 634 (or a set of instructions), query-management module 636 (or a set of instructions), publishing module 638 (or a set of instructions), bid-management module 640 (or a set of instructions), monitoring module 642 (or a set of instructions), layout module 644 (or a set of instructions), and/or encryption module 646 (or a set of instructions). Note that one or more of these program modules (or sets of instructions) may constitute a computer-program mechanism.

During operation, merchant-feed module 630 may receive merchant feeds 648, including product information. Then, keyword-extraction module 632 may extract and/or generate keywords 650, and keyword evaluator 634 may determine activation conditions 652 of keywords 650 using search index 328.

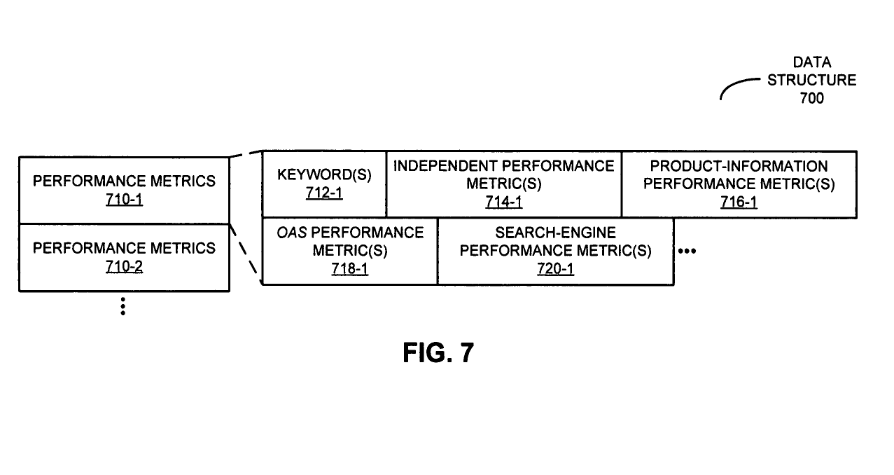

Next, query-management module 636 may calculate one or more performance metrics 654 associated with keywords 650 using product information in merchant feeds 648, product-search index 308, etc. As shown in FIG. 7, which presents a block diagram illustrating a data structure 700 for use in computer system 600 (FIG. 6), the one or more performance metrics, such as performance metrics 710-1, may include: a keyword(s) 712-1, a performance metric(s) that is independent of the product information (a so-called independent performance metric 714-1), a performance metric(s) that is based on the product information (a so-called product-information performance metric 716-1), an OAS performance metric(s) 718-1; and/or a search-engine performance metric(s) 720-1.

Referring back to FIG. 6, query-management module 636 may select a subset 656 of the keywords based on an estimated viability 658 (such as an estimated profitability) of keywords 650 when used in the OAS using the one or more performance metrics 654. Furthermore, publishing module 638 may publish subset 656 to the OAS for use in an online advertising campaign (such as one on a search engine and/or a comparison-shopping engine).

During the online advertising campaign, bid-management module 640 may bid on one or more groups of keywords 660 using one or more bid amounts 662 that are based on the estimated profitability of the one or more groups of keywords 660. Then, monitoring module 642 monitors the resulting traffic to one or more e-commerce websites 664, which includes determining one or more financial performance metrics 666 associated with e-commerce websites 664 (such as revenue of the one or more e-commerce websites 664).

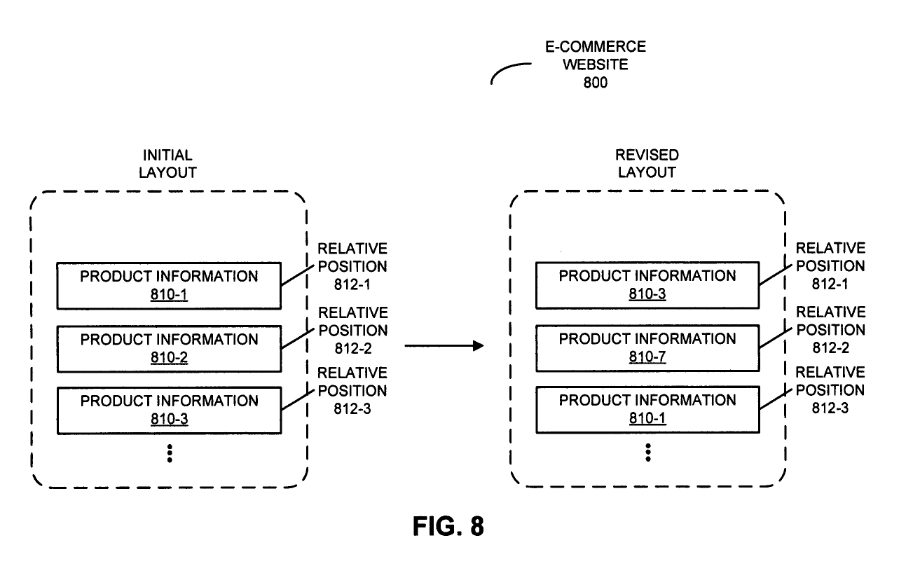

Moreover, layout module 644 may adjust one or more layouts 668 of one or more of e-commerce websites 664 based on the one or more determined financial performance metrics 666. This is illustrated in FIG. 8, which illustrates changes to a layout of an e-commerce website 800, including changes to product information 810 that is displayed on e-commerce website 800 and/or changes to relative positions 812 of product information 810.

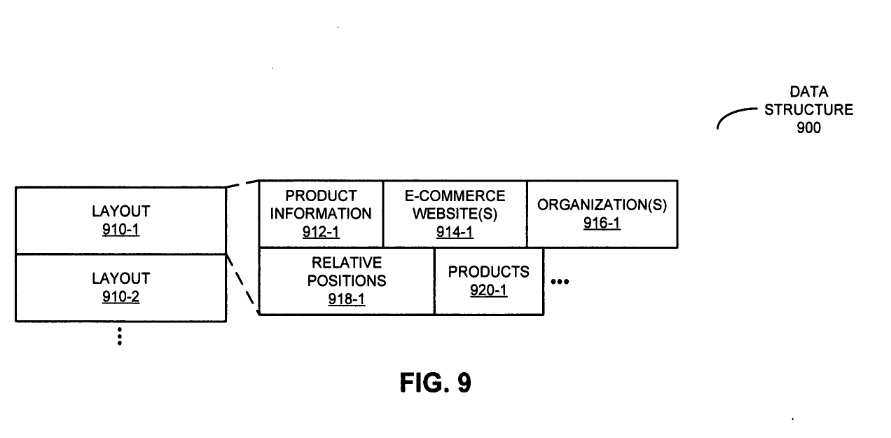

Note that the adjustments to the layout may be stored in a data structure. This is shown in FIG. 9, which presents a block diagram illustrating a data structure 900 for use in computer system 600 (FIG. 6). In this data structure, the one or more layouts, such as layout 910-1, may include: product information 912-1 that is displayed on e-commerce website(s) 914-1 (which are associated with one or more organization 916-1) and relative positions 918-1 of the displayed product information 912-1 on the e-commerce website(s) 914-1. Note that product information 912-1 is associated with products 920-1 provided by organizations 916-1.

Referring back to FIG. 6, bid-management module 640 may modify bid amounts 662 for the one or more groups of keywords 660 based on the one or more determined financial performance metric 666. Note that operations performed by computer system 600 may be repeated: once, after a time interval since a previous instance or continuously (i.e., on an ongoing basis).

Because the aforementioned information may be sensitive in nature, in some embodiments at least some of the data stored in memory 624 and/or at least some of the data communicated using communication module 628 is encrypted using encryption module 646.

Instructions in the various modules in memory 624 may be implemented in: a high-level procedural language, an object-oriented programming language, and/or in an assembly or machine language. Note that the programming language may be compiled or interpreted, e.g., configurable or configured, to be executed by the one or more processors 610.

Although computer system 600 is illustrated as having a number of discrete items, FIG. 6 is intended to be a functional description of the various features that may be present in computer system 600 rather than a structural schematic of the embodiments described herein. In practice, and as recognized by those of ordinary skill in the art, the functions of computer system 600 may be distributed over a large number of servers or computers, with various groups of the servers or computers performing particular subsets of the functions. In some embodiments, some or all of the functionality of computer system 600 may be implemented in one or more application-specific integrated circuits (ASICs) and/or one or more digital signal processors (DSPs).

Computers and servers in search-engine marketing system 300 (FIG. 3) and/or computer system 600 may include one of a variety of devices capable of manipulating computer-readable data or communicating such data between two or more computing systems over a network, including: a personal computer, a laptop computer, a mainframe computer, a portable electronic device (such as a cellular phone or PDA), a server and/or a client computer (in a client-server architecture). Moreover, these devices may communicate over a network, such as: the Internet, World Wide Web (WWW), an intranet, LAN, WAN, MAN, or a combination of networks, or other technology enabling communication between computing systems.

Search-engine marketing system 300 (FIG. 3), computer system 600, data structure 700 (FIG. 7), e-commerce website 800 (FIG. 8) and/or data structure 900 (FIG. 9) may include fewer components or additional components. Moreover, two or more components may be combined into a single component, and/or a position of one or more components may be changed. In some embodiments, the functionality of search-engine marketing system 300 (FIG. 3) and/or computer system 600 (FIG. 6) may be implemented more in hardware and less in software, or less in hardware and more in software, as is known in the art.

While the preceding discussion illustrated the use of the management technique in the context of an OAS, in other embodiments these techniques may be used to manage bid amounts in a wide variety of markets, including markets for advertising that are implemented in convention print media (such as magazines, newspapers, coupons, etc.). Furthermore, in some embodiments the published keywords may be individual-specific, i.e., the subset of keywords may be used to implement a tailored and/or targeted advertising-campaign that focuses on a specific individual. Such an advertising-campaign may occur dynamically, for example, based on the location of an individual based on the location of a portable electronic device (e.g., a cellular telephone) that is associated with the individual.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for managing keyword bid amounts in an online advertising system (OAS), the method comprising:
bidding on a group of keywords in the OAS using bid amounts that are based on an estimated profitability of the group of keywords, wherein the group of keywords are associated with products provided by organizations;
monitoring resulting traffic to an electronic-commerce (e-commerce) website, wherein the monitoring involves determining a financial performance metric associated with the e-commerce website;
adjusting, using a computer, a layout of the e-commerce website based on the determined financial performance metric, wherein the layout includes product information that is displayed on the e-commerce website and relative positions of the displayed product information on the e-commerce website, and wherein the product information is associated with the products provided by the organizations; and
modifying the bid amounts for the group of keywords based on the determined financial performance metric.

2. The method of claim 1, wherein the financial performance metric includes revenue of the e-commerce website.

3. The method of claim 2, wherein the revenue is based on a traffic volume to the e-commerce website and revenue per user visit to the e-commerce website.

4. The method of claim 3, wherein the revenue per user visit is based on the bid amounts and user click-through rates (CTRs) for icons on the e-commerce website that are associated with the products.

5. The method of claim 1, wherein dynamically adjusting the layout maximizes the determined financial performance metric.

6. The method of claim 1, wherein the bidding, the monitoring, the adjusting and the modifying operations are performed on an ongoing basis.

7. The method of claim 1, wherein adjusting the layout is performed once, after a time interval since a previous adjustment or continuously.

8. The method of claim 1, wherein modifying the bid amounts is performed once, after a time interval since the bid amounts were previously modified or continuously.

9. The method of claim 1, wherein the method further comprises increasing the bid amounts above values that are based on the estimated profitability of the group of keywords to increase traffic volume and a quality of the traffic to the e-commerce website; and
wherein the quality of the traffic includes users with increased revenue per user visit to the e-commerce website relative to the revenue per user visit associated with other users when the bid amounts equal the values.

10. The method of claim 1, wherein the e-commerce website includes a comparison-shopping engine;
wherein the product information displayed on the comparison-shopping engine is associated with web pages or websites of the organizations; and
wherein a user is referred to the comparison-shopping engine in response to the user activating an icon in paid search results that are generated by a search engine in response to a search query of the user.

11. The method of claim 1, wherein the method further comprises deactivating one or more keywords in the group of keywords if a web page or website of an organization, which provides a product associated with the one or more keywords, is offline, thereby maintaining the financial performance metric associated with the e-commerce website;
wherein deactivating the one or more keywords involves removing associated bid amounts from the OAS and terminating subsequent processing of the one or more keywords in the method; and
wherein the method further comprises reactivating the one or more keywords in the group of keywords when the web page or website of the organization is back online.

12. The method of claim 1, wherein the OAS provides paid search results associated with a search engine in response to search queries from users.

13. The method of claim 1, wherein the estimated profitability of a given keyword in the group of keywords is determined based on an estimated revenue per click and an estimated CTR of an icon on the e-commerce website that is associated with an organization that provides a given product.

14. A computer-program product for use in conjunction with a computer system, the computer-program product comprising a non-transitory computer-readable storage medium and a computer-program mechanism embedded therein, to manage keyword bid amounts in an OAS, the computer-program mechanism including:
instructions for bidding on a group of keywords in the OAS using bid amounts that are based on an estimated profitability of the group of keywords, wherein the group of keywords are associated with products provided by organizations;
instructions for monitoring resulting traffic to an e-commerce website, wherein the monitoring involves determining a financial performance metric associated with the e-commerce website;
instructions for adjusting a layout of the e-commerce website based on the determined financial performance metric, wherein the layout includes product information that is displayed on the e-commerce website and relative positions of the displayed product information on the e-commerce website, and wherein the product information is associated with the products provided by the organizations; and
instructions for modifying the bid amounts for the group of keywords based on the determined financial performance metric.

15. The computer-program product of claim 14, wherein the financial performance metric includes revenue of the e-commerce website;
wherein the revenue is based on a traffic volume to the e-commerce website and revenue per user visit to the e-commerce website; and
wherein the revenue per user visit is based on the bid amounts and user CTRs for icons on the e-commerce website that are associated with the products.

16. The computer-program product of claim 14, wherein the computer-program mechanism further includes instructions for increasing the bid amounts above values that are based on the estimated profitability of the group of keywords to increase traffic volume and a quality of the traffic to the e-commerce website; and
wherein the quality of the traffic includes users with increased revenue per user visit to the e-commerce website relative to the revenue per user visit associated with other users when the bid amounts equal the values.

17. The computer-program product of claim 14, wherein the e-commerce website includes a comparison-shopping engine;
wherein the product information displayed on the comparison-shopping engine is associated with web pages or websites of the organizations; and
wherein a user is referred to the comparison-shopping engine in response to the user activating an icon in paid search results that are generated by a search engine in response to a search query of the user.

18. The computer-program product of claim 14, wherein the computer-program mechanism further includes instructions for deactivating one or more keywords in the group of keywords if a web page or website of an organization, which provides a product associated with the one or more keywords, is offline, thereby maintaining the financial performance metric associated with the e-commerce website;
wherein deactivating the one or more keywords involves removing associated bid amounts from the OAS and terminating subsequent processing of the one or more keywords in the method; and
wherein the computer-program mechanism further includes instructions for reactivating the one or more keywords in the group of keywords when the web page or website of the organization is back online.

19. The computer-program product of claim 14, wherein the OAS provides paid search results associated with a search engine in response to search queries from users.

20. A computer system, comprising:
a processor;
memory; and
a program module, wherein the program module is stored in the memory and configurable to be executed by the processor to manage keyword bid amounts in an OAS, the program module including:
instructions for bidding on a group of keywords in the OAS using bid amounts that are based on an estimated profitability of the group of keywords, wherein the group of keywords are associated with products provided by organizations;
instructions for monitoring resulting traffic to an e-commerce website, wherein the monitoring involves determining a financial performance metric associated with the e-commerce website;
instructions for adjusting a layout of the e-commerce website based on the determined financial performance metric, wherein the layout includes product information that is displayed on the e-commerce website and relative positions of the displayed product information on the e-commerce website, and wherein the product information is associated with the products provided by the organizations; and
instructions for modifying the bid amounts for the group of keywords based on the determined financial performance metric.
